(19) United States
(12) Patent Application Publication
(10) Pub. No.: US 2017/0061473 A1
(43) Pub. Date: Mar. 2, 2017

(54) MANAGING ONLINE AD SERVING

(71) Applicant: Linkedin Corporation, Mountain View, CA (US)

(72) Inventors: Lihong Pei, Mountain View, CA (US); Hardik N. Bati, Santa Clara, CA (US)

(21) Appl. No.: 14/840,436

(22) Filed: Aug. 31, 2015

(51) Int. Cl. G06Q 30/02

(52) U.S. Cl. CPC G06Q 30/0249

(57) ABSTRACT

A machine may be configured to manage serving online ads. For example, the machine receives a communication from at least one of a primary source of communications or a secondary source of communications. The communication references a campaign of online ads served on behalf of an advertiser and indicates an exhaustion of a budget value associated with the campaign. The primary source of communications and the secondary source of communications are redundant sources of communications to the control system. The communication is generated by the primary source of communications or the secondary source of communications based on a tracked ad consumption event. The machine identifies, based on the communication, a campaign identifier associated with the campaign. The machine generates, based on the communication, a request to deactivate the campaign. The machine causes a deactivation of the campaign based on the request.

### CROSS REFERENCE TO RELATED APPLICATIONS

This application is related to U.S. patent application Ser. No. 14/809,819 (Attorney Docket No. 3080.D82US1) by Poon et al., filed on Jul. 27, 2015, and U.S. patent application Ser. No. 14/813,831 (Attorney Docket No. 3080.D80US1) by Bhamidipati et al., filed on Jul. 30, 2015, which are hereby incorporated herein by reference in their entirety.

### TECHNICAL FIELD

The present application relates generally to the processing of data, and, in various example embodiments, to systems, methods, and computer program products for managing online ad serving.

### BACKGROUND

Online advertising debuted as a new advertising medium in the mid-1990s to allow advertisers to promote their products and services on the Internet. Publishers (e.g., website owners) ran online ads on their web sites for the advertisers. The earliest ad serving software utilized by the publishers allowed the display of banner ads in the browsers of the users visiting the publishers' websites. In time, other types of online advertising have appeared, such as sponsored ads, affiliate ads, pay-per-click ads, etc.

As online advertising became more prevalent, certain methods for selling online advertising became more common. The Cost Per Thousand (also “CPM”) model was one of the earliest forms of selling online advertising and was based on an agreed rate for every one thousand impressions served. The Cost Per Click (also “CPC) model was often used and allowed publishers to charge advertisers a higher rate when users clicked on ads.

In addition to selling ad spots on their websites, the publishers are responsible to some degree for managing the advertising on their web sites. Generally, the publisher ensures that the online advertising campaign is set up properly and is receiving the online traffic promised to the advertiser. An online advertising campaign (also “advertising campaign,” “ad campaign,” or “campaign”) may specify one or more types of advertising products (also “ad products”) to be delivered during a campaign delivery period and a collection of common settings that a creative or a group of creatives associated with an ad product should abide by. A creative is a form of advertising material, such as a banner, Hyper Text Markup Language (HTML) form, Flash file, etc. Common creative types include images (e.g., GIF or JPEG images), executable programs (e.g., Java applets), interactive media (e.g., Flash or HTML5), or streaming audio/video.

Generally, the publisher also provides reports regarding the advertising campaign to the advertiser. These reports may include campaign performance reports and billing reports. At the most basic level, billing reports provide an accounting of delivered ads (e.g., within certain campaigns) and costs associated with the delivered ads or campaigns, billable to the advertiser.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2 is a block diagram illustrating components of a control system, according to some example embodiments;

FIG. 3 is a block diagram illustrating communications among an event tracker, a primary communication source, a secondary communication source, and the control system, according to some example embodiments;

FIG. 4 is a diagram illustrating a representation of various types of data utilized or generated by the primary communication source and/or secondary communication source, according to some example embodiments;

FIG. 5 is a flowchart illustrating a method for managing online ad serving, according to some example embodiments;

FIG. 6 is a flowchart illustrating a method for managing online ad serving, and representing step 508 of the method illustrated in FIG. 5 in more detail, according to some example embodiments;

FIG. 7 is a flowchart illustrating a method for managing online ad serving, and representing additional steps of the method illustrated in FIG. 6, according to some example embodiments;

FIG. 8 is a flowchart illustrating a method for managing online ad serving, and representing additional steps of the method illustrated in FIG. 6, according to some example embodiments;

FIG. 9 is a flowchart illustrating a method for managing online ad serving, and representing additional steps of the method illustrated in FIG. 5, according to some example embodiments;

FIG. 10 is a block diagram illustrating a mobile device, according to some example embodiments; and

FIG. 11 is a block diagram illustrating components of a machine, according to some example embodiments, able to read instructions from a machine-readable medium and perform any one or more of the methodologies discussed herein.

### DETAILED DESCRIPTION

Example methods and systems for managing online ad serving are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

In some example embodiments, a social networking service, such as LinkedIn®, is a publisher of online advertising that publishes (e.g., displays, presents, serves, or shows) online ads on behalf of one or more advertisers. Advertisers may come to the publisher to reach members of the social networking service and build long-term relationships with them through online advertising campaigns. The members of the social networking service may be a unique audience, and the social networking service may have a unique context that is very hard to find at scale anywhere else.

In some instances, the publisher utilizes an advertising auction to identify, from among the online ads of a number of advertisers, an online ad (also an “ad”) to be shown to a particular target audience. For example, when a page that can display an online ad loads on a web page of the publisher or a member scrolls through the member's web feed (e.g., a data format used for providing members with frequently updated content) provided by the publisher, the publisher periodically generates an online ad (e.g., a Sponsored Update, InMail, etc.). When there is an opportunity for an online ad to be shown, the publisher runs an auction to determine which online ad to show. For any given auction, there can be many bids from competing advertisers looking to reach the member.

An advertiser may choose to pay when the ad is shown (based on the CPM model) or when people click on the ad (based on the CPC model). The CPM model is often preferred when the advertiser wants to ensure that the ad is shown to as many people in a target audience as possible. The CPC model may be preferred for performance advertising, when the advertiser wants the publisher to show the ad to a target audience whose members are most likely to click on the content of the ad. Under the CPC model, the advertiser pays when someone in a particular target audience clicks on the content, company name, or company logo as presented in or with the ad.

Traditionally, in addition to identifying auction winning ads and serving the ads to the target audience, the publisher tracks the online ad consumption events pertaining to interactions by users with the online ads (e.g., impressions, clicks, conversions, etc.). The publisher may also generate reports that indicate the costs associated with the online ad consumption events (also “ad consumption events,” “consumption events,” or “events”).

In some example embodiments, an ad delivery system (also an “ad serving system”) over-delivers online ads above a particular budget set by the advertiser. For example, a remaining budget value associated with a particular ad should be updated (e.g., decreased) based on the costs of the ad consumption events associated with the particular ad. Due to a system failure, the remaining budget value is not being updated and represents an erroneous amount. Based on the erroneous value of the remaining budget, the publisher continues to serve the particular ad. This leads to the over-delivery of the particular ad above the budget value set by the advertiser associated with the particular ad. A control system is designed to manage the serving of online ads to users such that the over-delivery of ads is minimized and, as a result, the costs associated with the over-delivered ads are reduced.

In certain example embodiments, the control system controls the serving of online ads based on communications received from a primary communication source or a secondary communication source. The communications may include notifications of exhausted budget values associated with a campaign identifier that identifies a campaign, with an account identifier that identifies a particular advertiser, or with another budget control level. For example, the control system receives a communication from at least one of a primary source of communications or a secondary source of communications. The communication references a campaign of online ads served on behalf of an advertiser and indicates an exhaustion of a budget value associated with the campaign. The control system identifies, based on the communication, a campaign identifier associated with the campaign. The control system generates, based on the communication, a request to deactivate the campaign as a result of the exhaustion of the budget value. The control system causes, based on the request, a deactivation of the campaign.

In some example embodiments, one or more billing reporting systems may serve as sources of communication to the control system. A billing reporting system may be a system that tracks events of consumption, by users, of online ads, generates and adjusts event cost values and budget-related values based on the tracked events, and generates and communicates billing reports that describe the delivery of online ads on behalf of an advertiser, the consumption of online ads by the users, and the costs associated with the consumed online ads.

In various example embodiments, a billing reporting system is designed to scale in order to support a large number of campaigns per account and to accommodate future capacity growth. The billing reporting system generates and transmits ad billing reports in a timely fashion to front-end applications. The billing reporting system provides an offline reporting mechanism for generating reports that consume a large amount of data or reports for customizable date ranges and granularities that may not be supported in the traditional reporting systems. The billing reporting system may also generate reports at a variety of budget control levels, such as an account level, a campaign level, a campaign group level (e.g., campaigns grouped according to a common attribute, such as a product or service, a geographic location, a goal, etc.), a daily level, a seasonal level, etc. Also, the billing reporting system is designed to accommodate budget controls at additional levels.

In some instances, an ad delivery system over-delivers online ads above a particular budget set by the advertiser. In various embodiment, the billing reporting system adjusts the billable values in a report, based on account, campaign group, campaign, daily, or total budgets, to not include the costs associated with the over-delivered ads.

According to some example embodiments, a real-time billing reporting system acts as a communication source to the control system when it communicates to the control system that a particular budget is exhausted (e.g., a particular budget-related value, such as a remaining budget value, has been exceeded). For example, the real-time billing reporting system accesses, in real time, an event cost value associated with an event of consumption of an online ad. The online ad may be displayed on behalf of an advertiser. The advertiser may be associated with an account identifier. The real-time billing reporting system also accesses, in real time, a remaining budget value associated with the account identifier. The real-time billing reporting system determines, in real time, that the event cost value associated with the event exceeds the remaining budget value. The real-time billing reporting system generates, in real time, an adjusted event cost value to correspond to the remaining budget value based on the determining that the event cost value exceeds the remaining budget value. The real-time billing reporting system generates, in real time, a real-time billing report including the adjusted event cost value.

The real-time billing reporting system also transmits a communication (e.g., a signal, a notification, an event, etc.) to the control system to notify the control system that a budget associated with the campaign identifier has been exhausted based on the determination that the event cost value associated with the event exceeds the remaining budget value associated with the campaign identifier. The control system, based on the communication received from the real-time billing reporting system, causes a deactivation of the campaign that includes the online ad.

Similarly, the real-time billing reporting system may also transmit a communication to the control system to notify the control system that a budget associated with the account identifier has been exhausted based on the determination that the event cost value associated with the event exceeds the remaining budget value associated with the account identifier. The control system, based on the communication received from the real-time billing reporting system, may cause a deactivation of the campaigns associated with the account identifier.

In certain example embodiments, an offline billing reporting system acts as a communication source to the control system when it communicates to the control system that a particular budget is exhausted (e.g., a particular budget-related value, such as a remaining budget value, has been exceeded). The offline billing reporting system may determine an offline event cost value (also an “offline-determined event cost value” or an “event cost value determined based on historical event data”) associated with the event of online ad consumption. The offline event cost value is an event cost value that is associated with the event and that, in some instances, is adjusted based on various factors (e.g., an adjustment rule, a comparison with a particular budget, etc.) In some instances, offline cost values are generated by an offline job performed by a large-scale distributed storage and processing framework (e.g., a job performed by a Hadoop system, also called a “Hadoop job”) based on historical event data pertaining to one or more events during a particular period of time (e.g., the events that occurred during a day). The historical event data is also compliant with a high Service-Level Agreement (SLA) level (e.g., a guarantee of data accuracy, redundancy mechanisms to protect against loss of data, etc.). The offline billing reporting system may facilitate the tracking of the historical event data in a highly reliable fashion to meet various operational, technical, legal, or business requirements (e.g., redundancy and/or accuracy of data, Sarbanes-Oxley Act (SOX) compliance, SLAs, etc.). Reports generated based on offline cost values are highly accurate and may be used for final billing reporting. In some instances, the advertiser is charged for the online advertising provided by the publisher based on a final billing report.

The offline billing reporting system also transmits a communication (e.g., a signal, a notification, an event, etc.) to the control system to notify the control system that a budget associated with the campaign identifier has been exhausted based on a determination that the offline event cost value associated with an event of online ad consumption exceeds a remaining budget value associated with the campaign identifier. The determination that the budget associated with the campaign identifier has been exhausted may be made by a component of the offline billing reporting system, such as a budget control module. In some example embodiments, the offline billing reporting system (or a component of the offline billing reporting system, such as a budget control module) transmits the communication in real time based on the determination that the budget associated with the campaign identifier has been exhausted. The control system, based on the communication received from the offline billing reporting system, causes a deactivation of the campaign that includes the online ad.

Similarly, the offline billing reporting system may also transmit a communication (e.g., a signal, a notification, an event, etc.) to the control system to notify the control system that a budget associated with the account identifier has been exhausted based on a determination that the offline event cost value associated with an event of online ad consumption exceeds a remaining budget value associated with the account identifier. The determination that the budget associated with the account identifier has been exhausted may be made by a component of the offline billing reporting system, such as a budget control module. In some example embodiments, the offline billing reporting system (or a component of the offline billing reporting system, such as a budget control module) transmits the communication in real time based on the determination that the budget associated the account identifier has been exhausted. The control system, based on the communication received from the offline billing reporting system, may cause a deactivation of the campaigns associated with the account identifier.

The offline billing reporting system also transmits a communication (e.g., a signal, a notification, an event, etc.) to the control system to notify the control system that a budget associated with the account identifier has been exhausted based on a determination that the offline event cost value associated with an event of online ad consumption exceeds a remaining budget value associated with the account identifier. The determination that the budget associated with the account identifier has been exhausted may be made by a component of the offline billing reporting system, such as a budget control module. In some example embodiments, the offline billing reporting system (or a component of the offline billing reporting system, such as a budget control module) transmits the communication in real time based on the determination that the budget associated the account identifier has been exhausted. The control system, based on the communication received from the offline billing reporting system, causes a deactivation of the campaign that includes the online ad.

In various example embodiments, the offline billing reporting system and the real-time billing reporting system serve as the primary communication source and the secondary communication source, respectively, to the control system. The utilization of both the offline billing reporting system and the real-time billing reporting system as sources of communications to the control system facilitates higher SLA-levels of the ad serving, billing, and reporting functions provided by the online ad publisher than if only one billing reporting system were employed as a source of communication to the control system. One of the technical benefits achieved by the disclosed billing reporting systems is that they provide valuable redundancy at the input level of the control system which translates into higher operational reliability of the control system.

In certain example embodiments, the primary communication source and the secondary communication source are included in the control system. In some example embodiments, one or more functionalities of the primary communication source, the secondary communication source, or both, are performed by one or more modules of the control system.

In various example embodiments, the real-time billing report may be utilized as a temporary (e.g., ad hoc) report pertaining to a period of time, a particular campaign, a group of campaign, an account, or a suitable combination thereof. The real-time billing report may be displayed, in real time, in a user interface of a device associated with a user. The real-time billing report may serve to inform the user about one or more events of online ad consumption of an online ad associated with an online advertising campaign. The real-time billing report may also include information regarding a spent budget, a remaining budget, and a total budget associated with the advertising campaign. The information presented to the user in the real-time billing report may be updated in real-time, as new events are registered.

A final billing report generated based on offline event cost values may be utilized as a conclusive report pertaining to a period of time, a particular campaign, a group of campaign, an account, or a suitable combination thereof. The final billing report may be used to charge the advertiser for the online advertising delivered on behalf of the advertiser by the publisher to one or more users.

In some example embodiments, a billing reporting system generates a billing report that includes various online ad metrics pertaining to online ad consumption events corresponding to interactions by users with the online ads (e.g., impressions, clicks, conversions, etc.). The billing report may also indicate the costs associated with particular types of events and/or amounts billable to the advertiser based on various types of events, campaigns, or accounts. The billing report (e.g., the real-time billing report, the final billing report, etc.) may be presented in a dashboard. In some instances, the report is displayed in the dashboard in real time. The dashboard, in addition to displaying the contents of the report, may also display various online ad metrics pertaining to the events on which the report is based.

Additionally or alternatively, a real-time billing reporting system may generate, in real time, an online ad over-delivery report based on data pertaining to over-delivery of online ads associated with a particular account identifier. A real-time billing reporting system may present, in real time, the online ad over-delivery report in a dashboard. The dashboard, in addition to displaying the contents of the over-delivery report may also display various online ad metrics pertaining to the events on which the over-delivery report is based. The over-delivery report may be used internally by one or more employees of the publisher to see, in real time, how much money was lost due to over-delivery during a particular period of time.

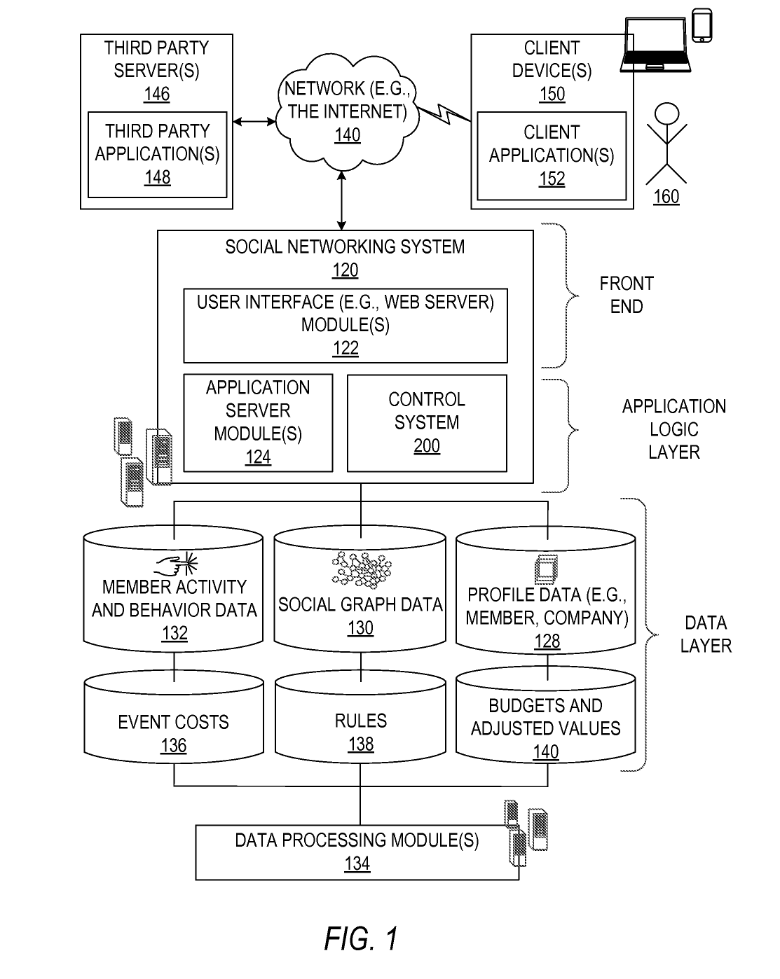

An example method and system for generating metrics or billing reports for online advertising may be implemented in the context of the client-server system illustrated in FIG. 1. As illustrated in FIG. 1, the billing reporting system 200 is part of the social networking system 120. As shown in FIG. 1, the social networking system 120 is generally based on a three-tiered architecture, consisting of a front-end layer, application logic layer, and data layer. As understood by one of ordinary skill in the art, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132. An example of such activity and behavior data is the identifier of an online ad consumption event associated with the member (e.g., an online ad viewed by the member), the date and time when the online ad event took place, an identifier of the creative associated with the online ad consumption event, a campaign identifier of an ad campaign associated with the identifier of the creative, etc.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social networking service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130. In some example embodiments, members may receive digital communications (e.g., advertising, news, status updates, etc.) targeted to them based on various factors (e.g., member profile data, social graph data, member activity or behavior data, etc.)

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include the control system 200, which is described in more detail below.

Further, as shown in FIG. 1, a data processing module 134 may be used with a variety of applications, services, and features of the social networking system 120. The data processing module 134 may periodically access one or more of the databases 128, 130, 132, 136, 138, or 140, process (e.g., execute batch process jobs to analyze or mine) profile data, social graph data, member activity and behavior data, event costs, rules, budget values, or adjusted values, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In certain example embodiments, the data processing module 134 is a large-scale distributed storage and processing framework (e.g., a Hadoop system). In some example embodiments, the data processing module 134 may include multiple servers, such as Hadoop servers for processing large data sets. The data processing module 134 may process data in real time, according to a schedule, automatically, or on demand.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

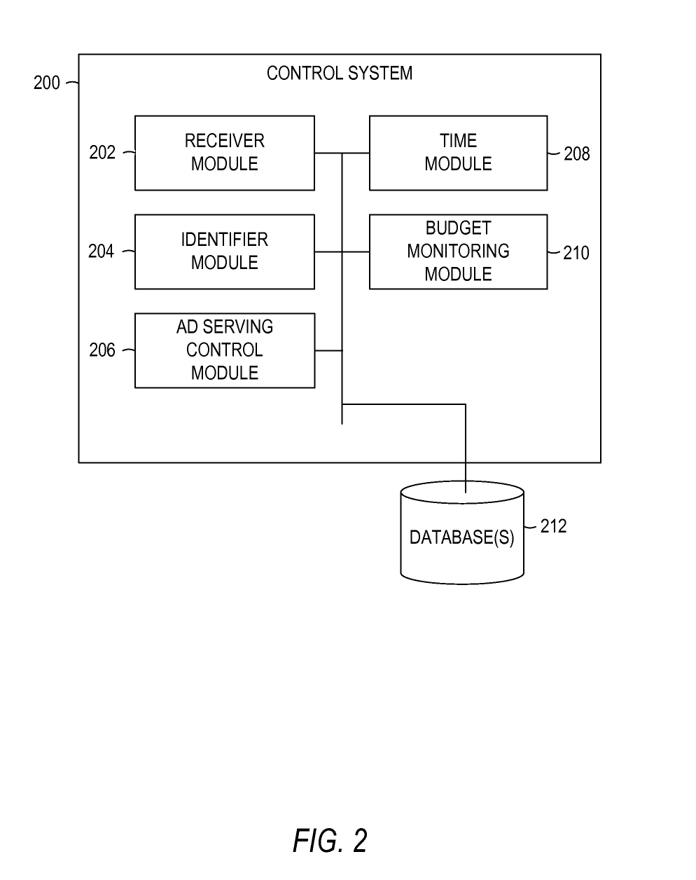

FIG. 2 is a block diagram illustrating components of the control system 200, according to some example embodiments. As shown in FIG. 2, the control system 200 includes a receiver module 202, an identifier module 204, an ad serving control module 206, a time module 208, and a budget monitoring module 210, all configured to communicate with each other (e.g., via a bus, shared memory, or a switch). The modules of FIG. 2 may be written in JAVA. The modules of FIG. 2 may be part of the ad serving system.

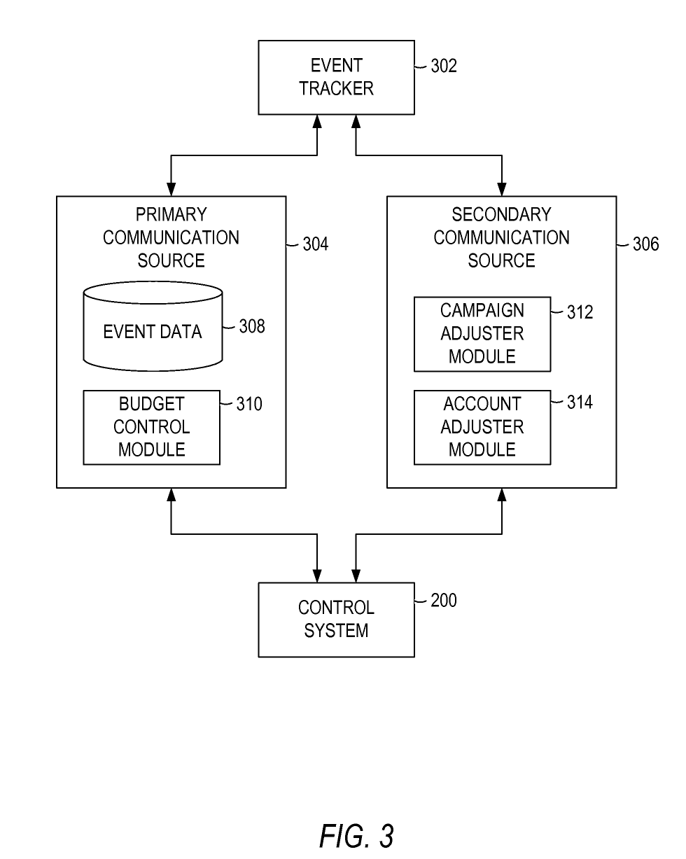

According to some example embodiments, the receiver module 202 of the control system 200 receives a communication from at least one of a primary source of communications or a secondary source of communications. The communication references a campaign of online ads (e.g., by including a campaign identifier) served on behalf of an advertiser. The communication also indicates an exhaustion of a budget value associated with the campaign. The communication may also include an account identifier associated with the campaign. The primary source of communications and the secondary source of communications are redundant sources of communications to the control system 200. For example, both the primary source of communications and the secondary source of communications may provide communications (e.g., a first communication by the primary source of communications and a second communication by the secondary source of communications) to the control system which include notifications of the exhaustion of the budget value associated with the campaign. Thus, the control system may receive an input from the primary source of communications, another input from the secondary source of communications, or an input from each of the two sources of communications. All of these inputs may indicate that the budget value associated with the campaign has been exhausted. The communications generated by the primary source of communications or the secondary source of communications, or both, are based on a tracked ad consumption event of one or more consumption events that are tracked by an event tracker, as described below at FIG. 3.

The identifier module 204 identifies, based on the communication, a campaign identifier associated with the campaign. The identifier module 204 generates, based on the communication, a request to deactivate the campaign. The request may be generated as a result of the exhaustion of the budget value.

The ad serving control module 206 causes, based on the request, a deactivation of the campaign. The deactivation of the campaign may include stopping the serving of the online ads pertaining to the campaign to users. In some example embodiments, the campaign is deactivated for a particular period of time that is smaller than the duration of the campaign.

There may be various reasons to deactivate a campaign. Examples of such reasons are a campaigned is deemed to be fraudulent, a campaign end date is reached, a campaign is running out of daily budget, a campaign is running out of lifetime budget, the account that the campaign belongs to is paused (e.g., suspended), the account is running out of daily or lifetime budget, etc.

One or more of these reasons may be used to construct checks utilized in determining whether a campaign should be re-activated at a later time. For example, to be re-activated the data available for a campaign is analyzed to confirm that the campaign is not fraudulent, a campaign end date is not reached, the campaign is not running out of daily budget, a campaign is not running out of lifetime budget, the account that the campaign belongs to is not suspended, the account is not running out of daily or lifetime budget, etc. The campaign is re-activated when it passes one or more checks. Failing a check may prevent the campaign from participating in the index matching. In some embodiments, the checks are done through negative filters during index matching.

In some example embodiments, a campaign is considered deactivated if it is not included in the process of matching one or more online advertising campaigns to members of the social networking service. A deactivated campaign may be filtered out of the matching process, for example, via a negative filter mechanism.

For example, when a campaign is running out of daily budget (e.g., has almost completed the campaign's daily budget), a record in the ad server associates the campaign identifier with a statement such as “campaign_completion_for_day=${beginning time of the specific day when the campaign's daily budget is running out}.” During the matching process, each ad request may include a filter, such as “campaign_completion_for_day!=${beginning time of the specific day when the campaign's daily budget is running out}.” During the index matching, based on the filter in an ad request, campaigns that have daily budgets that are about to run out on the particular day (e.g., have campaign identifiers associate with a statement such as “campaign_completion_for_day=${beginning time of the specific day when the campaign's daily budget is running out}”) are identified and filtered out.

The time module 208 identifies an expiration of the particular period of time. The time module 208 may also determine that the particular period of time has not expired.

The budget monitoring module 210 determines that the budget value has increased. In some instances, the budget monitoring module 210 may determine that the budget value has increased based on accessing a database 212 (e.g., the budgets and adjusted values database 140) and identifying the current budget value. In other instances, the budget monitoring module 210 may determine that the budget value has increased based on receiving a notification that pertains to an increased budget value from another module of the control system 200 (or from another system).

In some example embodiments, a real-time change data capture system (also “Databus”) may be used to capture (e.g., identify) change data (e.g., events). Databus provides a timeline-consistent stream of change capture events for a database. It enables applications to watch a database, view, and process updates in near real-time. Databus provides a complete after-image of every new or changed record as well as deletes, while maintaining timeline consistency and transactional boundaries.

In some example embodiments, Databus includes a database connector to listen for changes and maintain a clock or sequence value, an in-memory relay that keeps recent changes for efficient retrieval, a bootstrap service (or database) that enables long lookback queries (including from the beginning of time), and a client that provides a simple API to get changes since a point in time. The social networking service may utilize Databus to propagate various data (e.g., profile, connection, company updates, etc.) among databases utilized by the social networking service. For example, if a member adds a position, a standardization service generates a canonical version of an identifier of the company associated with the position, which will be added to the profile and the people search index. According to another example, connection and group updates are propagated into recommendation systems.

As discussed above, Databus may work together with database systems and identify changes in the databases. A budget value (e.g., a campaign budget value, an account budget value, a daily budget value, etc.) may be specified in a record of a database that is associated with a particular account. Databus may identify a change (e.g., a change in a budget value) in a database and generate a Databus event. The ad serving system is configured to listen (e.g., registered to listed) to Databus events associated with campaign and account tables in the database, and the changes associated with the campaigns or accounts are sent to the ad serving system. Accordingly, the ad serving system may access the changes associated with a campaign or account (e.g., campaign budget changes or account budget changes).

In some example embodiments, the ad serving control module 206 causes a re-activation of the campaign based on the identifying, by the time module 208, of the expiration of the particular period of time, the determining, by the budget monitoring module 210, that the budget value has increased, or both.

For example, the budget monitoring module 210 determines an increase in the budget value associated with the campaign. The ad serving control module 206 causes a re-activation of the campaign based on the determining of the increase in the budget value.

In some example embodiments, when a campaign budget value (or an account budget value) is increased, the budget change is reflected in the record storing the respective budget value. Databus identifies that a database change has occurred and transmits an event pertaining to the budget change to the budget control module 310. The budget control module 310 may update the remaining budget value associated with the campaign (or with the account) based on the budget change, determine that the remaining budget value is greater than an event cost value, and may update an entry for the campaign (or account) in a serving_control table. When the serving_control table is updated, another Databus event is transmitted to the ad serving system. The ad serving system determines that the campaign (or account) is not associated with a budget-completed statement, and re-activates (e.g., restarts) the campaign (or a number of the campaigns associated with the account) to allow the campaign (or a number of campaigns associated with the account) to participate again in the campaign-member matching.

In certain example embodiments, the ad serving control module 206 generates a record indicating that the campaign is deactivated for the particular period of time, “Jun. 10, 2015 to Jun. 15, 2015” (e.g., “campaign_completion_for_day=${Jun. 10, 2015 to Jun. 15, 2015}”). The receiver module 202 receives a request to display an online ad included in the campaign. The request is associated with a time of a receipt of the request (e.g., “Jun. 16, 2015, 09:00”). The time module 208 determines, based on the record, that the time of the receipt of the request, “Jun. 16, 2015, 09:00,” is not included in the particular period of time (e.g., is outside the particular period of time), “Jun. 10, 2015 to Jun. 15, 2015.” The ad serving control module 206 causes a re-activation of the campaign based on the determining, by the time module 208, that the time of the receipt of the request is not included in the particular period of time. Accordingly, a negative filter utilized during index matching may be utilized to re-activate a deactivated campaign.

In various example embodiments, the campaign is deactivated for a remainder of a day. The day may be a first day. The time module 208 identifies the beginning of a second day subsequent to the first day. The ad serving control module 206 causes a re-activation of the campaign based on the identifying, by the time module 208, of the beginning of the second day.

For example, when a daily budget associated with a campaign is exhausted, a record pertaining to the daily budget for the campaign is generated in database 212 by the control system 200. The record may state “Completed For Day=June-11-2015,” which indicates that the daily budget for Jun. 22, 2015 has been exhausted. The record may be accessed by the ad serving system to determine whether an ad from the campaign should be used in the auction on a particular day.

For each ad serving request, the ad serving system may issue a command that includes a statement such as “Completed For Day !=June-11-2015” to identify campaigns whose daily budgets for Jun. 11, 2015 are not exhausted. Accordingly, the ads from the campaigns that have no remaining budgets left on Jun. 11, 2015 are not entered into the auction, and therefore are not served during the remainder of Jun. 11, 2015.

The next day, the ad serving system issues a command that includes a statement such as “Completed For Day !=June-12-2015” to identify campaigns whose daily budgets for Jun. 12, 2015 are not exhausted. At that time, the campaigns that were stopped on Jun. 11, 2015 (because their daily budgets were exhausted) are not filtered out, and may participate in the auction for choosing ads to be served to users.

An approach similar to the one described in the example above may be used for other periods of time. For example, a period (e.g., a day) is broken into smaller periods of time (e.g., hours). For a particular smaller period of time, a campaign is not served. The serving of the campaign may be re-started at the beginning of the next smaller period of time.

In some example embodiments, the campaign is re-started as soon as an increase in budget for the period of time is detected even though the period of deactivation has not yet expired.

To perform one or more of its functionalities, the control system 200 may communicate with one or more other systems. An integration system may integrate the control system 200 with one or more email server(s), web server(s), one or more databases, or other servers, systems, or repositories, such as the primary communication source or secondary communication source, as described below.

Any one or more of the modules described herein may be implemented using hardware (e.g., one or more processors of a machine) or a combination of hardware and software. For example, any module described herein may configure a hardware processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 212 (e.g., database 128, 130, 132, 136, 138, or 140).

FIG. 3 is a block diagram illustrating communications among an event tracker, a primary communication source, a secondary communication source, and the control system 200, according to some example embodiments. As shown in FIG. 3, the control system 200 may receive communications from the primary communications source 304, the secondary communication source 306, or both. Each of the primary communications source 304 and the secondary communication source 306 may receive notifications from the event tracker 302 which tracks online ad consumption events associated with the online ads served by the publisher on behalf of the advertisers. In some example embodiments, the event tracker 302 leverages a tracking database with one or more fields corresponding to various ad consumption events. The various ad consumption events may be ad impression or click tracking events which include revenue-related information. Certain of the event information is extracted and written into tracking database.

In some example embodiments, when a user logs in to a web site, an ad request is sent to an ad server. For example, a web page associated with the social networking service includes an ad slot which embeds an ad request call. When a browser application loads the web page, the browser application transmits the ad request call to the ad server.

The ad server identifies ads that match the logged-in user (e.g., based on member profile, member activity, etc.). For example, the ad server selects an ad utilizing index matching to match members of the social networking service with one or more ads from participating campaigns based on matching an attribute of the member's profile (e.g., “title: senior engineer”) and a target associated with an ad or a campaign (e.g., “title: senior engineer”). According to another example, the ad server selects an ad utilizing an ad auction to select the best performing ad (e.g., a second price auction).

In some instances, the ad serving system utilizes an advertising auction to identify, from among the online ads of a number of advertisers, an ad to be shown to a particular target audience. For example, when a page that can display an online ad loads on a web page of the publisher or a member scrolls through the member's web feed (e.g., a data format used for providing members with frequently updated content) provided by the publisher, the ad server periodically serves an ad (e.g., a Sponsored Update, InMail, etc.). When there is an opportunity for an ad to be shown, the ad serving system runs an auction to determine which ad to show. For any given auction, there can be many bids from competing advertisers looking to reach the member.

An advertiser may choose to pay when the ad is shown (based on the CPM model) or when people click on the ad (based on the CPC model). The CPM model is often preferred when the advertiser wants to ensure that the ad is shown to as many people in a target audience as possible. The CPC model may be preferred for performance advertising, when the advertiser wants the publisher to show the ad to a target audience whose members are most likely to click on the content of the ad. Under the CPC model, the advertiser pays when someone in a particular target audience clicks on the content, company name, or company logo as presented in or with the ad.

In some example embodiments, the auction utilized by the ad serving system is a second price auction. Generally, in a second price auction, the advertiser is charged just enough to beat the second highest bidder. For example, the winning advertiser has a bid of $5.00 cost per click, but the next highest bid is only $3.00. That means the winning advertiser only pays $3.01. This second price method lets each advertiser bid the absolute maximum they are willing to pay, but they are only charged just enough to win the auction.

The control system 200 may perform ad service control functions, such as determining whether to request that the ad server stop ads from being entered into the ad auction (e.g., second price auction). As discussed above, the control system 200 may stop ads from being entered in the ad auction by deactivating a campaign. By re-activating a campaign, the control system 200 allows the re-activated campaign to participate in the auction. During the auction, the ad serving system chooses a campaign from a plurality of campaigns to be presented for viewing by the user. The choosing may include sorting the campaigns based on the effective cost per impression, and selecting the highest ranked campaign.

In some instances, once an ad is displayed in the browser of the user, an ad impression event issues indicating that the ad has been shown. The event tracker 302 tracks the event. The event tracker 302 sends notifications pertaining to the ad impression event to both the primary communication source 304 and the secondary communication source 306. In one embodiment, and without limitation, the notifications pertaining to the ad impression event include event data pertaining to the ad impression event (e.g., a creative identifier that identifies the ad, a campaign identifier that identifies the campaign that includes the ad, an account identifier that identifies the account that is associated with the campaign, a time of the event, a user identifier, whether the user has clicked on the ad, etc.). The event data pertaining to the event is persisted (e.g., stored) to database 308 included in the primary communication source 304. The database 308 may also store related information, such as how many time the ad has been shown to or clicked on by users, or the cost associated with those events (e.g., the event cost to the advertiser).

The primary communication source 304 also includes a budget control module 310. Database 308 and the budget control module 310 are configured to communicate with each other (e.g., via a bus, shared memory, or a switch). In one embodiment, the budget control module 310 performs calculations and comparisons pertaining to various budget-related values associated with an account representing an advertiser or with an online ad campaign. For example, after each consumption event pertaining to an ad included in a campaign is registered, the budget control module 310 determines the remaining campaign budget value associated with the campaign. The determining of the remaining campaign budget value is based on the cost of the consumption event (e.g., by subtracting the cost of the event from the previous remaining campaign budget value).

The budget control module 310 also determines whether the cost of the consumption event has exceeded the remaining budget value. The determining whether the cost of the consumption event has exceeded the remaining budget value may include comparing the value of the cost of the consumption event and the remaining budget value. If the value of the cost of the consumption event is determined to be greater than the remaining budget value, the budget control module 310 makes the determination that the cost of the consumption event has exceeded the remaining budget value.

If the budget control module 310 determines that the budget associated with the campaign is not exhausted, the ad server continues to show ads included in the campaign. If, however, the budget control module 310 determines that the budget associated with the campaign is exhausted, the budget control module 310 issues a communication to the control system 200 referencing a campaign identifier of the campaign and indicating an exhaustion of the budget associated with the campaign. The control system 200 may then cause a deactivation of the campaign, for example, by requesting the ad server to stop serving ads included in the campaign.

Similarly, after each consumption event pertaining to an ad included in a campaign is registered, the budget control module 310 determines the remaining account budget value of an account associated with the campaign. The determining of the remaining account budget value is based on the cost of the consumption event (e.g., by subtracting the cost of the event from the previous remaining account budget value). The budget control module 310 also determines whether the cost of the consumption event has exceeded the remaining account budget. If the budget control module 310 determines that the budget associated with the account is not exhausted, the ad server continues to show ads included in the campaigns associated with the account. If, however, the budget control module 310 determines that the budget associated with the account is exhausted, the budget control module 310 issues a communication to the control system 200 referencing an account identifier of the account and indicating an exhaustion of the account budget. The control system 200 may then cause a deactivation of all of the campaigns associated with the account, for example, by requesting the ad server to stop serving ads included in the campaigns associated with the account.

If the primary communication source 304 fails to notify the control system 200 that the budget is exhausted, the control system 200 does not cause a deactivation of the campaign. As a result, over-delivery of ads beyond a particular budget occurs.

The use of the secondary communication source 306 is designed to address this issue. As described above, the event tracker 302 sends notifications pertaining to the ad impression event to both the primary communication source 304 and the secondary communication source 306. For example, the event tracker 302 attempts to write the event data associated with a particular event to the event database 308 (e.g., every few seconds) until it succeeds. The event tracker 302 also transmits a communication including the event data to the secondary communication source 306 (e.g., to the campaign adjuster module 312) at the first attempt of writing to the event database 308. If the event tracker 302 fails to write to the event database 308 at the first attempt, the event tracker 302 has already transmitted the event data to the secondary communication source 306. In a case when the primary source of communication 304, or one of its components, is down for a few minutes, the control system 200 may have already received an input from the secondary communication source 306 and may have caused a deactivation of a campaign if a particular budget has been exhausted.

As shown in FIG. 3, the secondary communication source 306 includes a campaign adjuster module 312 and an account adjuster module 314, both configured to communicate with each other (e.g., via a bus, shared memory, or a switch).

The campaign adjuster module 312 may access a campaign identifier from the communication that includes the event data and that was transmitted by the event tracker 302 to the secondary communication source 306. The campaign adjuster module 312 accesses a remaining campaign budget value pertaining to the campaign. The campaign adjuster module 312 may access a repository (e.g., a remote cache) which stores budget-related information (e.g., the remaining campaign budget value). The accessing of the remaining campaign budget value may be based on the campaign identifier included in the event data associated with the event registered by the event tracker 302.

The campaign adjuster module 312 may also determine that the event cost value associated with the event exceeds the remaining campaign budget value pertaining to the campaign (e.g., the campaign budget is exhausted). The campaign adjuster module 312 issues a communication to the control system 200 referencing a campaign identifier of the campaign and indicating an exhaustion of the campaign budget. The control system 200 may then cause a deactivation of the campaign, for example, by requesting the ad server to stop serving ads included in the campaign.

The account adjuster module 314 may access an account identifier from the communication that includes the event data and that was transmitted by the event tracker 302 to the secondary communication source 306. The account adjuster module 314 accesses a remaining account budget value pertaining to an account associated with the account identifier. The account is associated with one or more campaigns including the campaign. The account adjuster module 314 may access a repository (e.g., a remote cache) which stores budget-related information (e.g., the remaining account budget value). The accessing of the remaining account budget value may be based on the account identifier included in the event data associated with the event registered by the event tracker 302.

The account adjuster module 314 may also determine that the event cost value associated with the event exceeds the remaining account budget value pertaining to the account (e.g., the account budget is exhausted) by comparing the event cost value associated with the event and the remaining account budget value pertaining to the account. The account adjuster module 314 issues a communication to the control system 200 referencing an account identifier of the account and indicating an exhaustion of the account budget. The control system 200 may then cause a deactivation of all of the campaigns associated with the account, for example, by requesting the ad server to stop serving ads included in the campaigns associated with the account.

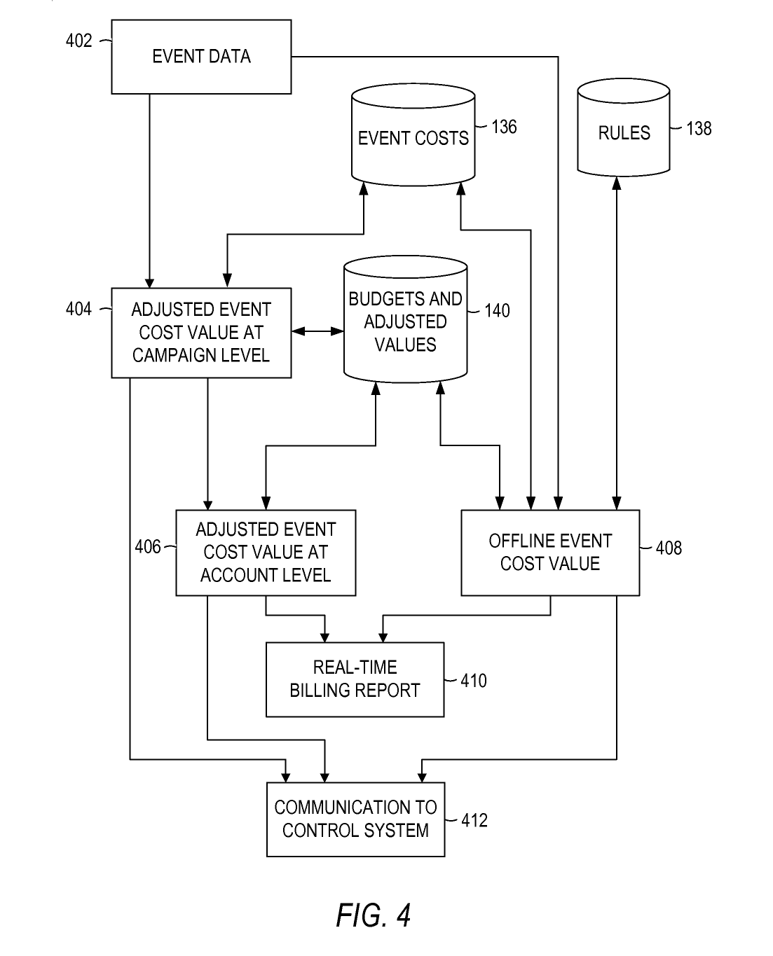

FIG. 4 is a diagram illustrating a representation of various types of data utilized or generated by the primary communication source 304, the secondary communication source 306, or both, according to some example embodiments. As shown in FIG. 4, the primary communication source 304, the secondary communication source 306, or both access (e.g., receive) event data 402 that pertains to an event of online ad consumption by a user. The online ad is associated with an account identifier representing an advertiser.

In some example embodiments, the event data 402 is received from an event tracking system (e.g., the event tracker 302) that monitors online ad consumption events by one or more users (e.g., members of the social networking service). The event data 402 may include metrics describing aspects of user interactions with online ads (e.g., impressions, clicks, clicksOther, conversions, costs, currency, likes, comments, shares, follows, viewContent, viewUpdate, viewCompany, etc.)

In some example embodiments, the event tracker 302 issues an event that includes event data 402, such as various budget-related values (e.g., a campaign remaining budget value, and account remaining budget value, etc.), an event cost value, a campaign identifier, an account identifier, creative identifier, etc. The campaign adjuster module 312 and the account adjuster module 314 may act as event consumers and may access any of the fields in the tracking events.

In some example embodiments, the event cost values associated with various consumption events are stored at the event costs database 136. The secondary communication source 306 may identify, in real time, a type of event (e.g., an impression type or a click event type) of a particular event based on the event data 402. The secondary communication source 306 may access an event cost value associated with the particular type of event and/or the account identifier from the event costs database 136. The event cost value may be different for different event types and for different accounts.

In certain example embodiments, the secondary communication source 306 may act as an event consumer of the events issues by the event tracker 302, may access any of the fields of the events issued by the event tracker 302, and may identify, in real time, a campaign identifier of a campaign that includes the online ad associated with the consumption event based on the event data 402 included in the event issued by the event tracker 302.

The secondary communication source 306 may also access, in real time, a remaining campaign budget value associated with the campaign identifier from the budgets and adjusted values database 140. The remaining campaign budget value represents a budget remaining in a campaign associated with the event. The remaining campaign budget value may be determined based on subtracting the spent campaign budget value associated with one or more other events pertaining to the campaign from the total campaign budget value associated with the campaign.

The secondary communication source 306 may determine, in real time, that the event cost value exceeds the remaining campaign budget value. The secondary communication source 306 may generate a communication 412 to the control system 200. The communication 412 may reference the campaign identifier and may indicate that the campaign budget value associated with the campaign has been exhausted.

The secondary communication source 306 may generate, in real-time, an adjusted event cost value 404, at the campaign level, to correspond to the remaining campaign budget value. In one embodiment, the adjusted event cost value 404 is equal to the remaining campaign budget value. The secondary communication source 306 may store the adjusted event cost value 404 determined at the campaign level in the budgets and adjusted values database 140.

The secondary communication source 306 may also access, in real time, a remaining account budget value associated with the account identifier from the budgets and adjusted values database 140. The remaining account budget value represents a budget remaining in an account associated with the campaign. In some example embodiments, the secondary communication source determines the remaining account budget value by subtracting the spent account budget value associated with one or more campaigns including the campaign from the total account budget value associated with the account.

The secondary communication source 306 may determine, in real time, that the adjusted event cost value 404 generated at the campaign level exceeds the remaining account budget value by comparing the event cost value associated with the event and the remaining account budget value pertaining to the account. The secondary communication source 306 may generate a communication 412 to the control system 200. The communication 412 may reference the campaign identifier, the account identifier, or both, and may indicate that the account budget value associated with the account has been exhausted.

The secondary communication source 306 may update, in real-time, the adjusted event cost value 404, at the account level, to correspond to the remaining account budget value. The secondary communication source 306 may store the adjusted event cost value 406 determined at the account level in the budgets and adjusted values database 140.

The secondary communication source 306 may reiterate this process for other event data 402 describing other ad consumption events associated with one or more online ads associated with the campaign identifier and/or account identifier. Accordingly, the adjusted event cost value 404 and/or the adjusted event cost value 406 is generated (e.g., adjusted, updated, etc.), in real time, based on each new event of consumption of the online ads associated with the campaign identifier and/or account identifier.

In certain example embodiments, the primary communication source 304 uses an offline job to generate reporting data based on historical event data associated with a particular time range (e.g., daily, weekly, monthly, etc.). The historical event data may include various information describing online ad consumption events (e.g., number of clicks, number of impressions, etc.). The historical event data is highly reliable and, in some instances, is more reliable than the event data utilized in the real time analysis described above. The historical event data is also compliant with a high Service-Level Agreement (SLA) level (e.g., a guarantee of data accuracy, redundancy mechanisms to protect against loss of data, etc.).

The primary communication source 304 accesses event data 402 (e.g., historical event data) pertaining to the event of consumption of the online ad. The online ad is associated with a creative and pertains to an online advertising campaign. The event data 402 may include a creative identifier for the online ad, a campaign identifier that indicates the campaign that includes the creative associated with the online ad, an account identifier that represents the account that includes the campaign, the cost associated with the event, etc.

The primary communication source 304 may determine, based on the event data 402, a type of event and an account identifier associated with the online ad consumption event, as well as a campaign identifier associated with the campaign that includes the online ad associated with the event. In some example embodiments, the primary communication source 304 accesses the event cost associated with the particular event from the event costs database 136. In other instances, the event cost value is accessed from the event data 402. The primary communication source 304 also access one or more rules associated with the account identifier from the rules database 138.

The one or more rules specify how to bill the account for the event. The one or more rules associated with a specific account may be generated based on the contract between the advertiser represented by the account and the publisher of the online advertising. For example, a rule may specify certain budgets for the account and for the campaigns included in the account.

In some example embodiments, a rule for adjustment of billable values may specify that the billable values associated with particular campaigns should be adjusted in some proportion if an over-delivery of ads occurs above a budget amount (e.g., a campaign budget value or an account budget value). The primary communication source 304 may look to the rules database 138 as the final authority and may correct the offline event cost values according to one or more billing rules.

In some instances, the primary communication source 304 may determine that the offline event cost value associated with an event exceeds the remaining campaign budget value associated with a campaign. The primary communication source 304 may generate a communication 412 to the control system 200. The communication 412 may reference the campaign identifier of the campaign and may indicate that the campaign budget value associated with the campaign has been exhausted.

In some example embodiments, the secondary communication source 306 may generate one or more real-time billing reports 410 to provide information pertaining to the online ad consumption events of the online advertising provided by the publisher on behalf of the advertiser. In some example embodiments, the secondary communication source 306 generates, in real time, a real-time billing report 410 including adjusted event cost values 406 pertaining to one or more events, offline event cost values 408 pertaining to one or more events, or both. For example, the secondary communication source 306 determines, in real time, that the offline event cost value 408 for a first event is not available (e.g., has not yet been determined by the offline job) and that the offline event cost value 408 for a second event is available. The secondary communication source 306 then generates, in real time, the real-time billing report 410 to include the adjusted event cost value 406 for the first event and the offline event cost value 408 for the second event.

In some example embodiments, the primary communication source 304, the secondary communication source 306, or both, compute over-delivery amounts representing over-deliveries of online ads. The primary communication source 304, the secondary communication source 306, or both, may generate ad over-delivery reports including the over-delivery amounts.

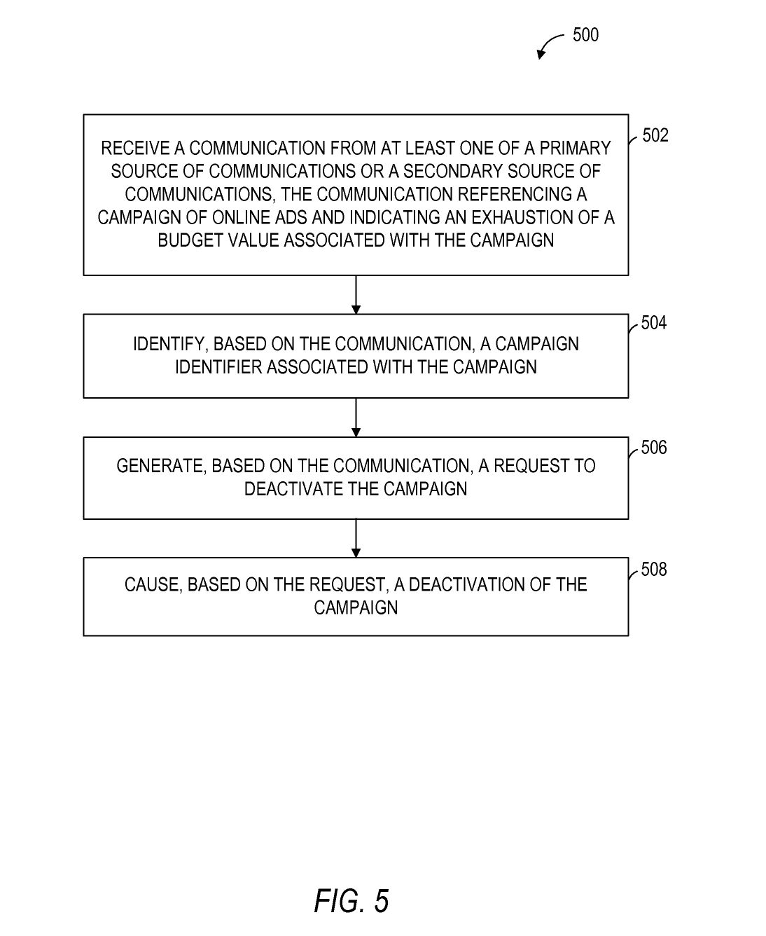

FIGS. 5-9 are flowcharts illustrating a method for managing online ad serving, according to some example embodiments. Operations in the method 500 illustrated in FIG. 5 may be performed using modules described above with respect to FIGS. 2 and 3. As shown in FIG. 5, method 500 may include one or more of method operations 502, 504, 506, and 508, according to some example embodiments.

At method operation 502, the receiver module 202 receives a communication from at least one of a primary source of communications or a secondary source of communications. The communication references a campaign of online ads served on behalf of an advertiser. The communication also indicates an exhaustion of a budget value associated with the campaign.

The primary source of communications and the secondary source of communications are redundant sources of communications to the control system 200. For example, both the primary source of communications and the secondary source of communications may provide communications (e.g., a first communication by the primary source of communications and a second communication by the secondary source of communications) to the control system which include notifications of the exhaustion of the budget value associated with the campaign. Thus, the control system may receive an input from the primary source of communications, another input from the secondary source of communications, or an input from each of the two sources of communications. All of these inputs may indicate that the budget value associated with the campaign has been exhausted. The communications generated by the primary source of communications or the secondary source of communications, or both, are based on a tracked ad consumption event of one or more consumption events that are tracked by an event tracker, as described above at FIG. 3.

At method operation 504, the identifier module 204 identifies a campaign identifier associated with the campaign. The identifying of the campaign identifier may be based on the communication.

At method operation 506, the identifier module 204 generates a request to deactivate the campaign. The request may be generated as a result of the exhaustion of the budget value. The generating of the request may be based on the communication.

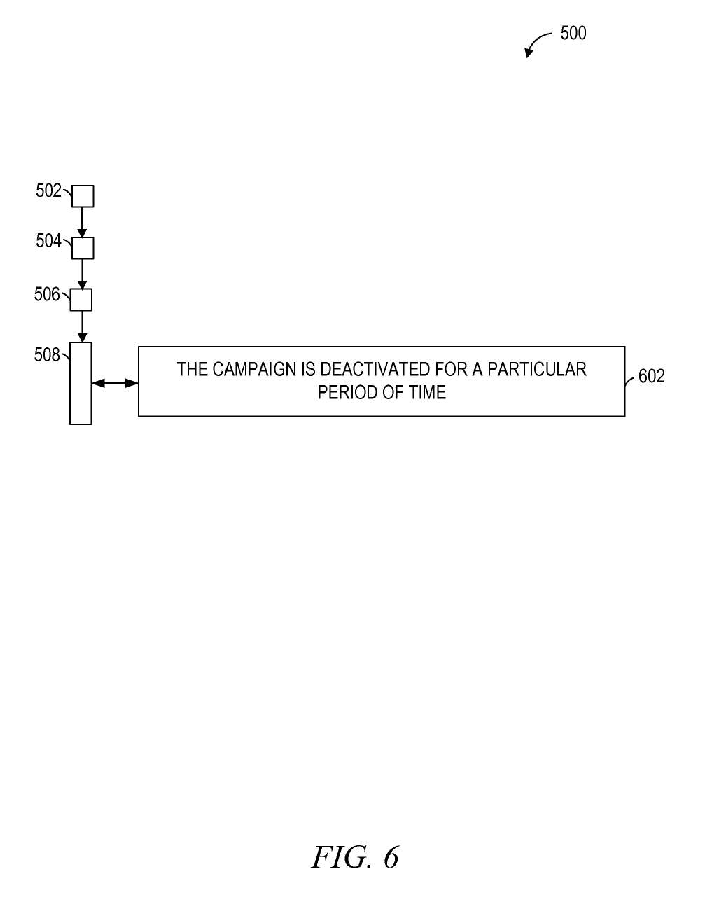

At method operation 508, the ad serving control module 206 causes a deactivation of the campaign. The deactivation of the campaign may be based on the request. The deactivation of the campaign may include stopping the serving of the online ads pertaining to the campaign to users. Further details with respect to the method operations of the method 500 are described below with respect to FIGS. 6-9.

As shown in FIG. 6, the method 500 may include operation 602, according to some example embodiments. Method operation 602 may be performed as part (e.g., a precursor task, a subroutine, or a portion) of method operation 506, in which the ad serving control module 206 causes a deactivation of the campaign.

At method operation 602, the ad serving control module 206 causes the deactivation of the campaign for a particular period of time. In some example embodiments, the particular period of time is smaller than the duration of the campaign.

In various example embodiments, the campaign is deactivated for a remainder of a day. The day may be a first day. The time module 208 identifies the beginning of a second day subsequent to the first day. The ad serving control module 206 causes a re-activation of the campaign based on the identifying, by the time module 208, of the beginning of the second day.

In some example embodiments, when a campaign is deactivated based on a communication received from the primary communication source 304 that indicates a daily budget completion for a particular day, the campaign is deactivated for the remainder of the day. When a campaign is deactivated based on a communication received the secondary communication source 306, the campaign is deactivated for a period of time that is less than a day (e.g., 20 minutes).

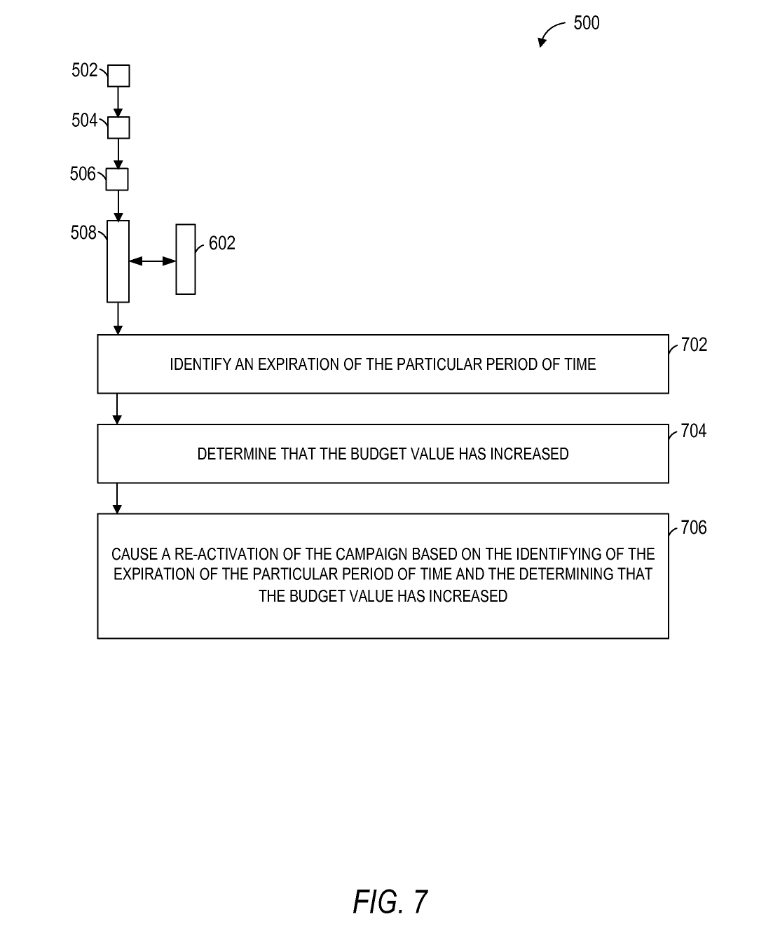

As shown in FIG. 7, the method 500 may include method operations 702, 704, and 706, according to some example embodiments. Method operation 702 may be performed after method operation 602, in which the ad serving control module 206 causes a deactivation of the campaign for a particular period of time. At method operation 702, the time module 208 identifies an expiration of the particular period of time.

Method operation 704 may be performed after method operation 702. At method operation 704, the budget monitoring module 210 determines that the budget value has increased. In some instances, the budget monitoring module 210 determines that the budget value has increased based on accessing a database 212 (e.g., the budgets and adjusted values database 140) and identifying the current budget value. In other instances, the budget monitoring module 210 determines that the budget value has increased based on receiving a notification that pertains to an increased budget value from another module of the control system 200 (or from another system).

Method operation 706 may be performed after method operation 704. At method operation 706, the ad serving control module 206 causes a re-activation of the campaign based on the identifying, by the time module 208, of the expiration of the particular period of time and the determining, by the budget monitoring module 210, that the budget value has increased.

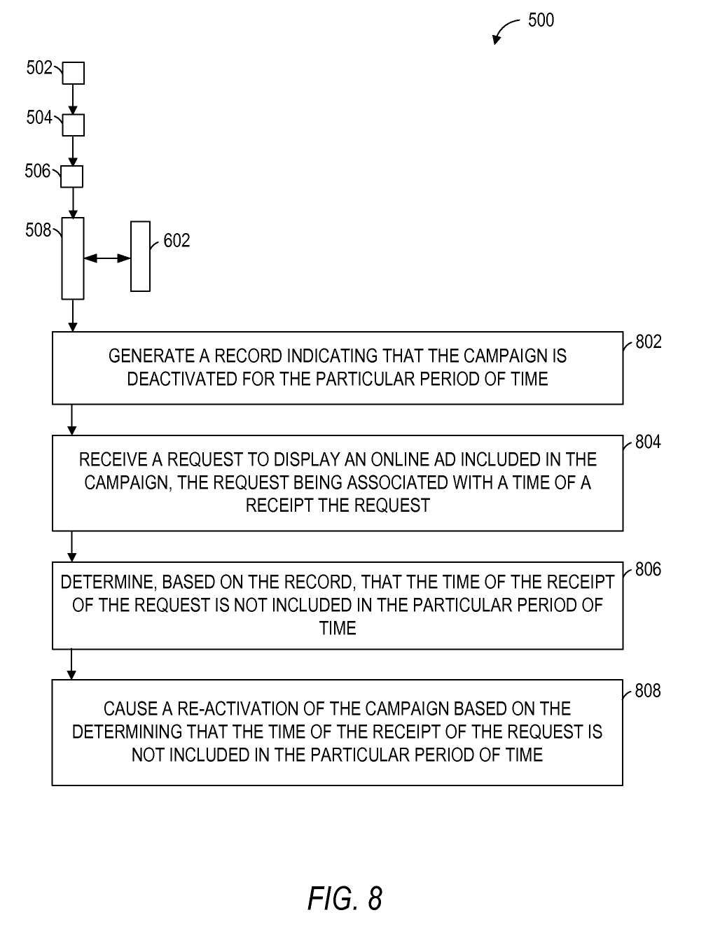

As shown in FIG. 8, the method 800 may include method operations 802, 804, 806, and 808, according to some example embodiments. Method operation 802 may be performed after method operation 602, in which the ad serving control module 206 causes a deactivation of the campaign for a particular period of time. At method operation 802, the ad serving control module 206 generates a record indicating that the campaign is deactivated for the particular period of time. The ad serving control module 206 may also store the record in the database 212.

Method operation 804 may be performed after method operation 802. At method operation 804, the receiver module 202 receives a request to display an online ad included in the campaign. The request is associated with a time of a receipt of the request.

Method operation 806 may be performed after method operation 804. At method operation 806, time module 208 determines that the time of the receipt of the request is not included in the particular period of time (e.g., is outside the period of time). The determining that the time of the receipt of the request is not included in the particular period of time may be based on the record generated by the ad serving control module 206.

Method operation 808 may be performed after method operation 806. At method operation 808, the ad serving control module 206 causes a re-activation of the campaign based on the determining, by the time module 208, that the time of the receipt of the request is not included in the particular period of time.

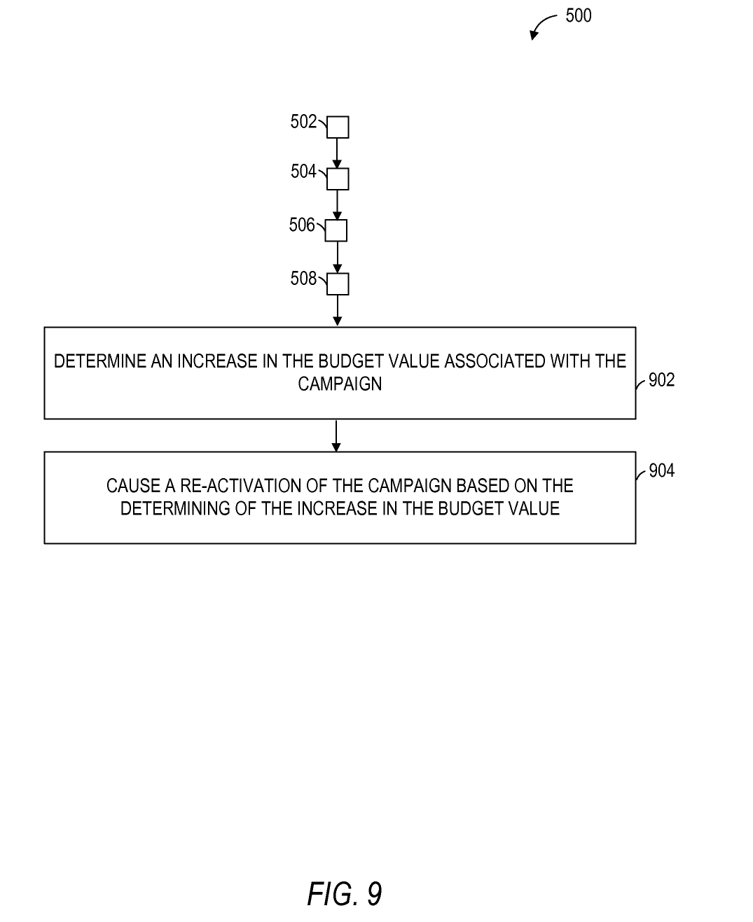

As shown in FIG. 9, the method 500 may include one or more of operations 902 and 904, according to some example embodiments. Method operation 902 is performed after method operation 508, in which the ad serving control module 206 causes a deactivation of the campaign. At method operation 902, the budget monitoring module 210 determines an increase in the budget value associated with the campaign.

Method operation 904 may be performed after method operation 902. At method operation 904, the ad serving control module 206 causes a re-activation of the campaign based on the determining of the increase in the budget value.

### Example Mobile Device

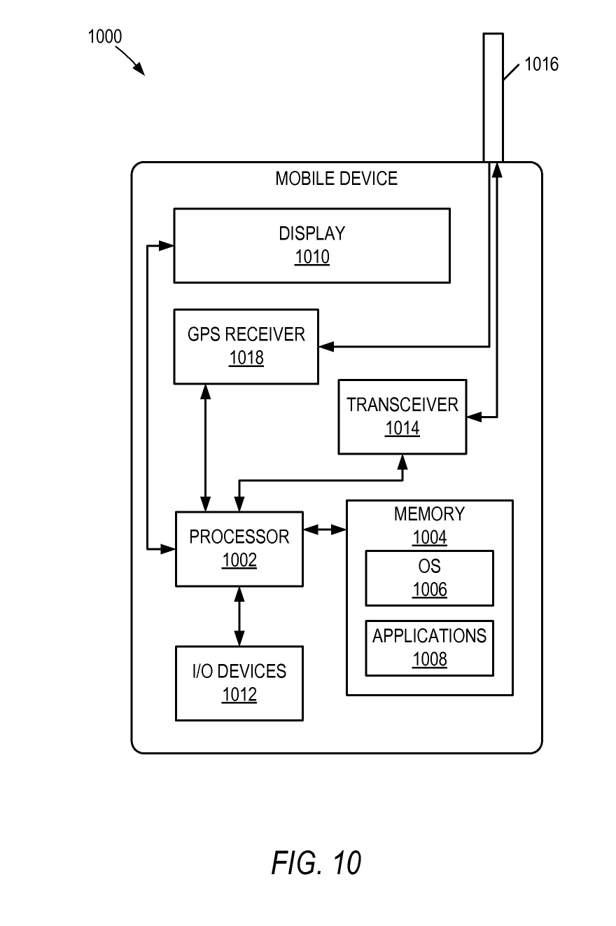

FIG. 10 is a block diagram illustrating a mobile device 1000, according to an example embodiment. The mobile device 1000 may include a processor 1002. The processor 1002 may be any of a variety of different types of commercially available processors 1002 suitable for mobile devices 1000 (for example, an XScale architecture microprocessor, a microprocessor without interlocked pipeline stages (MIPS) architecture processor, or another type of processor 1002). A memory 1004, such as a random access memory (RAM), a flash memory, or other type of memory, is typically accessible to the processor 1002. The memory 1004 may be adapted to store an operating system (OS) 1006, as well as application programs 1008, such as a mobile location enabled application that may provide LBSs to a user. The processor 1002 may be coupled, either directly or via appropriate intermediary hardware, to a display 1010 and to one or more input/output (I/O) devices 1012, such as a keypad, a touch panel sensor, a microphone, and the like. Similarly, in some embodiments, the processor 1002 may be coupled to a transceiver 1014 that interfaces with an antenna 1016. The transceiver 1014 may be configured to both transmit and receive cellular network signals, wireless data signals, or other types of signals via the antenna 1016, depending on the nature of the mobile device 1000. Further, in some configurations, a GPS receiver 1018 may also make use of the antenna 1016 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

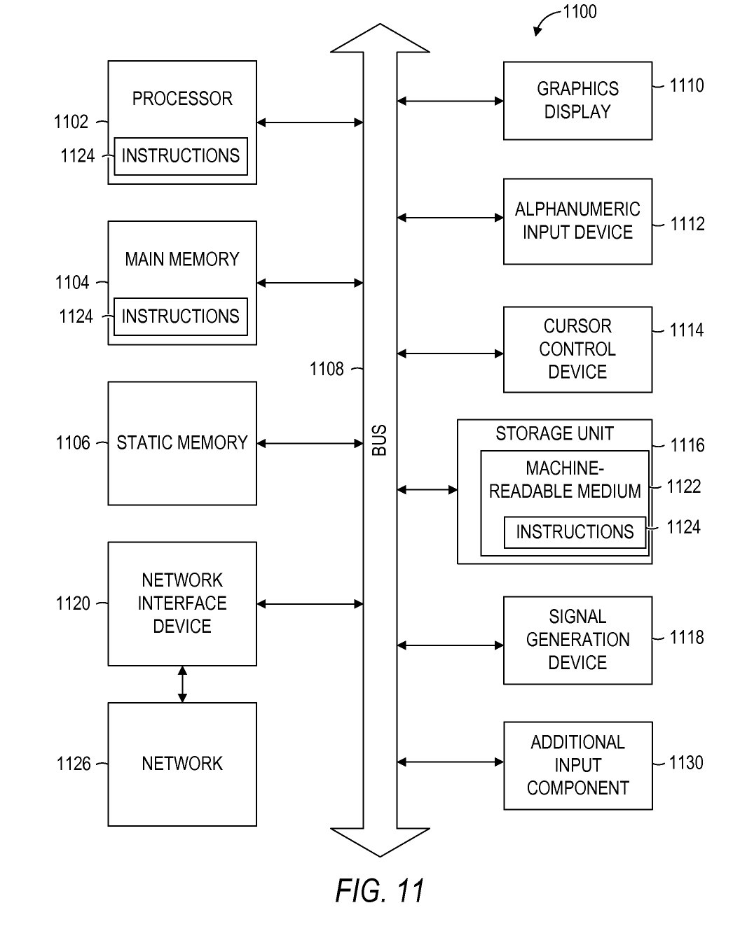

FIG. 11 is a block diagram illustrating components of a machine 1100, according to some example embodiments, able to read instructions 1124 from a machine-readable medium 1122 (e.g., a non-transitory machine-readable medium, a machine-readable storage medium, a computer-readable storage medium, or any suitable combination thereof) and perform any one or more of the methodologies discussed herein, in whole or in part. Specifically, FIG. 11 shows the machine 1100 in the example form of a computer system (e.g., a computer) within which the instructions 1124 (e.g., software, a program, an application, an applet, an app, or other executable code) for causing the machine 1100 to perform any one or more of the methodologies discussed herein may be executed, in whole or in part.

In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include any collection of machines that individually or jointly execute the instructions 1124 to perform all or part of any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The processor 1102 may contain microcircuits that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein.

The machine 1100 may further include a graphics display 1110 (e.g., a plasma display panel (PDP), a light emitting diode (LED) display, a liquid crystal display (LCD), a projector, a cathode ray tube (CRT), or any other display capable of displaying graphics or video). The machine 1100 may also include an alphanumeric input device 1112 (e.g., a keyboard or keypad), a cursor control device 1114 (e.g., a mouse, a touchpad, a trackball, a joystick, a motion sensor, an eye tracking device, or other pointing instrument), a storage unit 1116, an audio generation device 1118 (e.g., a sound card, an amplifier, a speaker, a headphone jack, or any suitable combination thereof), and a network interface device 1120.

The storage unit 1116 includes the machine-readable medium 1122 (e.g., a tangible and non-transitory machine-readable storage medium) on which are stored the instructions 1124 embodying any one or more of the methodologies or functions described herein. The instructions 1124 may also reside, completely or at least partially, within the main memory 1104, within the processor 1102 (e.g., within the processor's cache memory), or both, before or during execution thereof by the machine 1100. Accordingly, the main memory 1104 and the processor 1102 may be considered machine-readable media (e.g., tangible and non-transitory machine-readable media). The instructions 1124 may be transmitted or received over the network 1126 via the network interface device 1120. For example, the network interface device 1120 may communicate the instructions 1124 using any one or more transfer protocols (e.g., hypertext transfer protocol (HTTP)).

In some example embodiments, the machine 1100 may be a portable computing device, such as a smart phone or tablet computer, and have one or more additional input components 1130 (e.g., sensors or gauges). Examples of such input components 1130 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1124 for execution by the machine 1100, such that the instructions 1124, when executed by one or more processors of the machine 1100 (e.g., processor 1102), cause the machine 1100 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A method comprising:
enhancing a machine of a control system, the enhancing of the machine of the control system including incorporating one or more modules into one or more memories of the control system, the one or more modules configuring one or more hardware processors of the control system to perform operations comprising:
determining that an event cost value associated with a tracked ad consumption event exceeds a remaining budget value associated with a campaign identifier of a campaign of online ads served on behalf of an advertiser;
receiving, at the control system, a communication from at least one of a primary source of communications or a secondary source of communications, the communication referencing the campaign and indicating an exhaustion of a budget value associated with the campaign based on the determining that the event cost value exceeds the remaining budget value associated with the campaign identifier, the primary source of communications and the secondary source of communications being redundant sources of communications to the control system, the communication being generated by the primary source of communications or the secondary source of communications based on the tracked ad consumption event;
generating, based on the communication, a request to deactivate the campaign; and
causing a deactivation of the campaign based on the request.

2. The method of claim 1, wherein the campaign is deactivated for a particular period of time.

3. The method of claim 2, further comprising:
identifying an expiration of the particular period of time;
determining that the budget value has increased; and
causing a re-activation of the campaign based on the identifying of the expiration of the particular period of time and the determining that the budget value has increased.

4. The method of claim 2, further comprising:
generating a record indicating that the campaign is deactivated for the particular period of time;
receiving a request to display an online ad included in the campaign, the request being associated with a time of a receipt of the request;
determining, based on the record, that the time of the receipt of the request is not included in the particular period of time; and
causing a re-activation of the campaign based on the determining that the time of the receipt of the request is not included in the particular period of time.

5. The method of claim 1, wherein the campaign is deactivated for a remainder of a day.

6. The method of claim 5, wherein the day is a first day, the method further comprising:
identifying a beginning of a second day subsequent to the first day;
causing a re-activation of the campaign based on the identifying of the beginning of the second day.

7. The method of claim 1, further comprising:
determining an increase in the budget value associated with the campaign; and
causing a re-activation of the campaign based on the determining of the increase in the budget value.

8. A control system comprising:
one or more hardware processors; and
one or more modules incorporated into the control system to enhance a machine of the control system, the enhancing including configuring the one or more hardware processors to perform operations comprising:
determining that an event cost value associated with a tracked ad consumption event exceeds a remaining budget value associated with a campaign identifier of a campaign of online ads served on behalf of an advertiser;
receiving a communication from at least one of a primary source of communications or a secondary source of communications, the communication referencing the campaign and indicating an exhaustion of a budget value associated with the campaign based on the determining that the event cost value exceeds the remaining budget value associated with the campaign identifier, the primary source of communications and the secondary source of communications being redundant sources of communications to the control system, the communication being generated by the primary source of communications or the secondary source of communications based on the tracked ad consumption event;
generating, based on the communication, a request to deactivate the campaign; and
causing a deactivation of the campaign based on the request.

9. The system of claim 8, wherein the campaign is deactivated for a particular period of time.

10. The system of claim 9, wherein the operations further comprise:
identifying an expiration of the particular period of time;
determining that the budget value has increased; and
causing a re-activation of the campaign based on the identifying of the expiration of the particular period of time and the determining that the budget value has increased.

11. The system of claim 9, wherein the operations further comprise:
generating a record indicating that the campaign is deactivated for the particular period of time;
receiving a request to display an online ad included in the campaign, the request being associated with a time of a receipt of the request;
determining, based on the record, that the time of the receipt of the request is not included in the particular period of time; and
causing a re-activation of the campaign based on the determining that the time of the receipt of the request is not included in the particular period of time.

12. The system of claim 8, wherein the campaign is deactivated for a remainder of a day.

13. The system of claim 12, wherein the day is a first day, and wherein the operations further comprise:
identifying a beginning of a second day subsequent to the first day;
causing a re-activation of the campaign based on the identifying of the beginning of the second day.

14. The system of claim 8, wherein the operations further comprise:
determining an increase in the budget value associated with the campaign; and
causing a re-activation of the campaign based on the determining of the increase in the budget value.

15. A non-transitory machine-readable storage medium comprising instructions that, when incorporated into a control system as one or more modules implemented by one or more hardware processors of the control system, cause the one or more hardware processors to perform operations to enhance a machine of the control system, the operations comprising:
determining that an event cost value associated with a tracked ad consumption event exceeds a remaining budget value associated with a campaign identifier of a campaign of online ads served on behalf of an advertiser;
receiving, at the control system, a communication from at least one of a primary source of communications or a secondary source of communications, the communication referencing the campaign and indicating an exhaustion of a budget value associated with the campaign based on the determining that the event cost value exceeds the remaining budget value associated with the campaign identifier, the primary source of communications and the secondary source of communications being redundant sources of communications to the control system, the communication being generated by the primary source of communications or the secondary source of communications based on the tracked ad consumption event;
generating, based on the communication, a request to deactivate the campaign; and
causing a deactivation of the campaign based on the request.

16. The non-transitory machine-readable storage medium of claim 15, wherein the campaign is deactivated for a particular period of time.

17. The non-transitory machine-readable storage medium of claim 16, wherein the operations further comprise:
identifying an expiration of the particular period of time;
determining that the budget value has increased; and
causing a re-activation of the campaign based on the identifying of the expiration of the particular period of time and the determining that the budget value has increased.

18. The non-transitory machine-readable storage medium of claim 16, wherein the operations further comprise:
generating a record indicating that the campaign is deactivated for the particular period of time;
receiving a request to display an online ad included in the campaign, the request being associated with a time of a receipt of the request;
determining, based on the record, that the time of the receipt of the request is not included in the particular period of time; and
causing a re-activation of the campaign based on the determining that the time of the receipt of the request is not included in the particular period of time.

19. The non-transitory machine-readable storage medium of claim 15, wherein the campaign is deactivated for a remainder of a day.

20. The non-transitory machine-readable storage medium of claim 19, wherein the day is a first day, and wherein the operations further comprise:
identifying a beginning of a second day subsequent to the first day;
causing a re-activation of the campaign based on the identifying of the beginning of the second day.
